(19) United States
(12) Patent Application Publication
(10) Pub. No.: US 2020/0387291 A1
(43) Pub. Date: Dec. 10, 2020

(54) METHOD AND APPARATUS FOR DISPLAYING DIGITAL IMAGE

(71) Applicant: BOE TEHNOLOGY GROUPCO., LTD., Beijing (CN)

(72) Inventor: Qingguo Yang, Beijing (CN)

(21) Appl. No.: 16/768,455

(22) PCT Filed: Oct. 21, 2019
(86) PCT No.: PCT/CN2019/112175

§ 371 Date: May 29, 2020

(30) Foreign Application Priority Data
Oct. 22, 2018 (CN) 201811231662.4

(51) Int. Cl. G06F 3/0481; G06F 3/0484; G06F 21/36

(52) U.S. Cl. CPC G06F 3/04817; G06F 21/36; G06F 3/04845

(57) ABSTRACT

Embodiments of the present disclosure provide a method for displaying a digital image including: acquiring information of a digital stamp associated with a target digital image, wherein both the target digital image and the information of the digital stamp are associated with a target user account; and displaying the digital stamp on the target digital image according to the information of the digital stamp in response to displaying the target digital image.

### CROSS REFERENCE TO RELATED APPLICATION

The present disclosure is a 371 of PCT/CN2019/112175, filed on Oct. 21, 2019, which claims priority to Chinese Patent Application No. 201811231662.4, filed on Oct. 22, 2018, and entitled “DIGITAL IMAGE DISPLAY METHOD, DEVICE AND SYSTEM”, the entire contents of which are incorporated herein by reference.

### TECHNICAL FIELD

The present disclosure relates to the field of display technologies, and in particular, to a method and an apparatus for displaying a digital image, an electronic device, and a storage medium.

### BACKGROUND ART

With rapid development of Internet of Things technologies, display apparatus products have also developed accordingly. For displaying collected paintings or photos on a display screen disposed on a display apparatus, users can electronize the collected paintings or photos, and then transmit the collected paintings or photos to the display apparatus.

### SUMMARY

Embodiments of the present disclosure provides a method and an apparatus for displaying digital image.

At least one embodiment of the present disclosure provides a method for displaying a digital image. The method is applicable to an electronic device and includes:

acquiring information of a digital stamp associated with a target digital image, wherein both the target digital image and the information of the digital stamp are associated with a target user account; and

displaying the digital stamp on the target digital image according to the information of the digital stamp in response to displaying the target digital image.

In some embodiments, acquiring the information of the digital stamp associated with the target digital image includes:

receiving the information of the digital stamp sent by a digital image server, wherein the information of the digital stamp is generated and sent by a terminal to the digital image server; or

receiving the information of the digital stamp sent by the terminal; or

acquiring the information of the digital stamp locally from the electronic device;

wherein the terminal is associated with the target user account.

Exemplarily, the electronic device includes a display apparatus, and the display apparatus is configured to display a digital image; and acquiring the information of the digital stamp associated with the target digital image includes:

receiving the information of the digital stamp sent by a digital image server, wherein the information of the digital stamp is generated and sent by a terminal to the digital image server; or

receiving the information of the digital stamp sent by the terminal; or

receiving the information of the digital stamp locally from the electronic device, wherein

the terminal and the display apparatus are associated with the target user account.

Exemplarily, the electronic device includes the terminal, and acquiring the information of the digital stamp associated with the target digital image includes:

receiving the information of the digital stamp locally from the electronic device; or

receiving the information of the digital stamp sent by a digital image server, wherein the information of the digital stamp is generated and sent by another terminal to the digital image server; or

receiving the information of the digital stamp sent by the another terminal.

In some embodiments, displaying the digital stamp on the target digital image according to the information of the digital stamp in response to displaying the target digital image includes:

sending the information of the digital stamp to a display apparatus by using a digital image server, wherein the display apparatus is configured to display a digital image, the information of the digital stamp is intended to display the digital stamp by the display apparatus when the target digital image is displayed, and the terminal and the display apparatus are associated with the target user account.

In some embodiments, acquiring the information of the digital stamp locally from the electronic device includes:

controlling the electronic device to display a user interface, and displaying a plurality of digital stamp templates in the user interface;

receiving a process instruction for a target digital stamp template of the plurality of digital stamp templates, wherein the process instruction is intended to instruct to perform a selected operation on the target digital stamp template; and

performing the selected operation on the target digital stamp template according to the process instruction, to acquire the information of the digital stamp.

In some embodiments, the selected operation includes at least one of: zooming, update, text addition, and graphic modification.

In some embodiments, acquiring the information of the digital stamp locally from the electronic device includes:

acquiring an image including the digital stamp by an image acquisition component coupled to the electronic device; and

processing the image including the digital stamp to acquire the information of the digital stamp.

In some embodiments, the method for displaying the digital image further includes:

controlling the electronic device to display a user interface, and receiving a share instruction generated by a user by performing an operation on the user interface;

generating digital image share information according to the share instruction, wherein the digital image share information includes digital image update information and target information, the digital image update information including information of the target digital image and the information of the digital stamp, the target information including information indicative of a user account at a receiving end shared by the digital image update information, and the target information being associated with the user account; and

sending the digital image share information to the digital image server, wherein the digital image share information is intended to share the digital image update information with the user account at the receiving end indicated by the target information by the digital image server.

In some embodiments, the information of the digital stamp includes pattern information of the digital stamp and location information of the digital stamp.

In some embodiments, displaying the digital stamp on the target digital image according to the information of the digital stamp in response to displaying the target digital image includes:

displaying the digital stamp on a target area indicated by the location information of the target digital image according to the pattern information of the digital stamp.

In some embodiments, the location information of the digital stamp indicates that the digital stamp locates on an edge area of the target digital image or locates on a blank area of the target digital image.

In some embodiments, when the location information of the digital stamp indicates that the digital stamp locates on the blank area of the target digital image, the method further includes:

identifying a text area and an image area in the target digital image, and taking an area in the target digital image other than the text area and the image area as the blank area.

In some embodiments, the method for displaying the digital image, prior to acquiring the information of the digital stamp associated with the target digital image, the method further includes:

receiving the target digital image sent by the digital image server, wherein the target digital image is a digital image purchased with the target user account, or a digital image shared with the target user account by an account associated with the target user account, or a digital image uploaded by a terminal that is logged on to by using the target user account; and

associating the target digital image with the target user account.

At least one embodiment of the present disclosure provides an apparatus for displaying a digital image. The apparatus is applicable to an electronic device and includes:

a first acquiring module, configured to acquire information of a digital stamp associated with a target digital image, wherein both the target digital image and the information of the digital stamp are associated with a target user account; and

a controlling module, configured to control the display apparatus to display the digital stamp on the target digital image according to the information of the digital stamp in response to displaying the target digital image.

In some embodiments, the first acquiring module includes:

a first acquiring submodule, configured to receive the information of the digital stamp sent by a digital image server, wherein the information of the digital stamp is generated and sent by a terminal to the digital image server; or

a second acquiring submodule, configured to receive the information of the digital stamp sent by the terminal; or

a third acquiring submodule, configured to acquire the information of the digital stamp locally from the electronic device;

wherein the terminal and the display apparatus are associated with the target user account.

In some embodiments, the controlling module is configured to:

send the information of the digital stamp to the display apparatus by a digital image server, wherein the display apparatus is configured to display a digital image, the information of the digital stamp is intended to display the digital stamp by the display apparatus when the target digital image is displayed, and the terminal and the display apparatus are associated with the target user account.

In some embodiments, the controlling module is configured to control the electronic device to display a user interface, and display a plurality of digital stamp templates in the user interface;

the third acquiring submodule is configured to receive a process instruction for a target digital stamp template of the plurality of digital stamp templates, wherein the process instruction is intended to instruct to perform a selected operation on the target digital stamp template; and

the controlling module is configured to perform the selected operation on the target digital stamp template according to the process instruction, to acquire the information of the digital stamp.

In some embodiments, the third acquiring submodule is configured to:

acquire an image including the digital stamp by an image acquisition component; and the controlling module is further configured to process the image including the digital stamp to acquire the information of the digital stamp.

In some embodiments, the apparatus further includes:

a second acquiring module, configured to receive a share instruction from the user interface;

a second acquiring module, configured to control the electronic device to display a user interface, and receive a share instruction generated by a user by performing an operation on the user interface;

a generating module, configured to generate digital image share information according to the share instruction, wherein the digital image share information includes digital image update information and target information, the digital image update information including information of the target digital image and the information of the digital stamp, the target information including information indicative of a user account at a receiving end shared by the digital image update information, and the target information being associated with the user account; and

a sending module, configured to send the digital image share information to the digital image server, wherein the digital image share information is intended to share the digital image update information with the user account at the receiving end indicated by the target information by the digital image server.

In some embodiments, the information of the digital stamp includes pattern information of the digital stamp and location information of the digital stamp; and

the controlling module is configured to display the digital stamp on a target area indicated by the location information of the target digital image according to the pattern information of the digital stamp.

In some embodiments, the location information of the digital stamp indicates that the digital stamp locates on an edge area of the target digital image or locates on a blank area of the target digital image; and

the controlling module is further configured to identify a text area and an image area in the target digital image, and take an area in the target digital image other than the text area and the image area as the blank area.

At least one embodiment of the present disclosure provides an electronic device. The device includes:

a processor; and

a memory configured to store at least one computer instruction;

wherein when running the at least one computer instruction, the processor is enabled to perform the method for displaying the digital image as described above.

At least one embodiment of the present disclosure provides a computer-readable storage medium storing at least one computer instructions therein. When the at least one computer instruction in the computer-readable storage medium is executed by a processor in an electronic device, the electronic device is enabled to perform the method for displaying the digital image as described above.

At least one embodiment of the present disclosure provides a system for displaying a digital image. The system includes:

an electronic device, wherein an electronic device includes the apparatus for displaying the digital image as described above; or

the electronic device includes another apparatus for displaying the digital image as described above.

### BRIEF DESCRIPTION OF THE DRAWINGS

FIG. 1 is a schematic diagram of an implementation environment for a method for displaying a digital image according to an embodiment of the present disclosure;

FIG. 2 is a schematic diagram of an implementation environment for another method for displaying a digital image according to an embodiment of the present disclosure;

FIG. 3 is a schematic flowchart of a method for displaying a digital image according to an embodiment of the present disclosure;

FIG. 4 is a schematic flowchart of another method for displaying a digital image according to an embodiment of the present disclosure;

FIG. 5 is a schematic flowchart of a method for receiving information of a digital stamp according to an embodiment of the present disclosure;

FIG. 6 is a schematic diagram of a user interface of a display apparatus according to an exemplary embodiment of the present disclosure;

FIG. 7 is a schematic diagram of a user interface of another display apparatus according to an exemplary embodiment of the present disclosure;

FIG. 8 is a schematic flowchart of another method for receiving information of a digital stamp according to an embodiment of the present disclosure;

FIG. 9 is a schematic flowchart of a method for sharing a digital image according to an embodiment of the present disclosure;

FIG. 10 is a schematic diagram of an exemplary digital image according to an embodiment of the present disclosure;

FIG. 11 is a schematic flowchart of still another method for displaying a digital image according to an embodiment of the present disclosure;

FIG. 12 is a schematic flowchart of still another method for receiving information of a digital stamp according to an embodiment of the present disclosure;

FIG. 13 is a schematic flowchart of yet another method for receiving information of a digital stamp according to an embodiment of the present disclosure;

FIG. 14 is a schematic flowchart of another method for sharing a digital image according to an embodiment of the present disclosure;

FIG. 15 is a block diagram of an apparatus for displaying a digital image according to an embodiment of the present disclosure;

FIG. 16 is a schematic block diagram of a first obtaining module according to an embodiment of the present disclosure;

FIG. 17 is a schematic block diagram of another apparatus for displaying a digital image according to an embodiment of the present disclosure; and

FIG. 18 is a schematic structural diagram of an electronic device according to an embodiment of the present disclosure.

### DETAILED DESCRIPTION

Embodiments of the present disclosure are described in further detail with reference to the accompanying drawings, to present the objects, technical solutions, and advantages of the present disclosure more clearly.

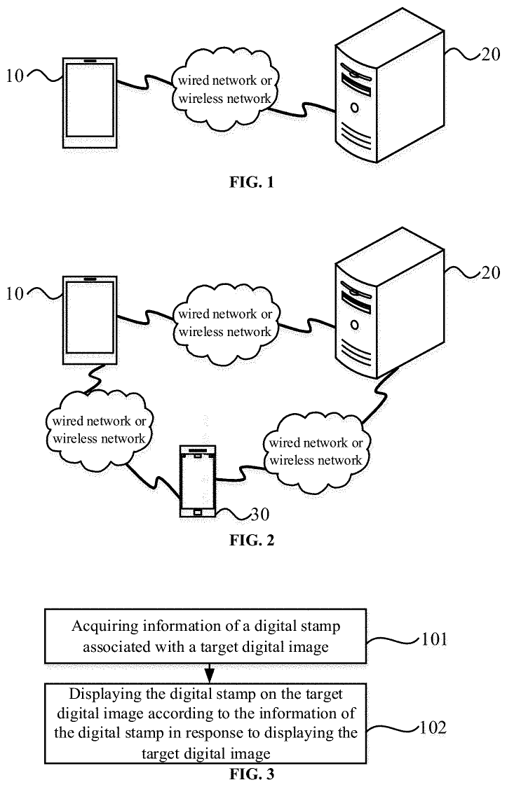

Referring to FIG. 1, in some embodiments of the present disclosure, an implementation environment for performing a method for displaying a digital image includes: a display apparatus 10 and a digital image server 20.

Referring to FIG. 2, in some embodiments of the present disclosure, an implementation environment for performing a method for displaying a digital image includes: a display apparatus 10, a digital image server 20, and a terminal 30.

In some embodiments, the display apparatus 10 may establish a communication connection to the digital image server 20 over a wired network or a wireless network.

In one example, the display apparatus 10 may include a processor and a memory. A digital image client may be installed in the memory, and may be run by the processor. The display apparatus 10 may communicate with the digital image server 20 by using the digital image client.

For example, the display apparatus 10 may establish a communication connection to the digital image server 20 by using a network address provided by the digital image server; for example, the display apparatus 10 may establish a communication connection to the digital image server 20 by using a website address provided by the digital image server, such as a uniform resource locator (URL). However, other address types such as IP address are also applicable.

For example, a communication connection between the display apparatus 10 and the digital image server 20 may be practiced by setting corresponding IP addresses and ports to push or pull data. For example, a port number is 6999.

In an embodiment of the present disclosure, the display apparatus 10 is configured to display a digital image. The digital image server 20 is configured to store and maintain the digital image.

In some embodiments, the terminal 30 may be connected to the display apparatus 10 and the digital image server 20 respectively over a wired network or a wireless network, and the display apparatus 10 may also be connected to the digital image server 20 over a wired network or a wireless network.

For example, a digital image client may be installed in both the display apparatus 10 and the terminal 30. By using the digital image client, the display apparatus 10 may establish a communication connection to the digital image server 20, and the terminal 30 may establish a communication connection to the digital image server 20.

For example, the display apparatus 10 and the terminal 30 may establish a communication connection to the digital image server 20 respectively by using the network address of the digital image server 20, for example, establishing a communication connection to the digital image server 20 by using a website address provided by the digital image server, such as a URL. However, other address types such as IP address are also applicable.

In an embodiment of the present disclosure, the display apparatus 10 may be fixed or movable. A type of a display panel mounted in the display apparatus 10 may be a liquid crystal display (LCD), an organic light-emitting diode (OLED), a quantum dot light emitting diode (QLED), or the like. The display apparatus may include a touch panel to receive a selection performed by a user on a displayed user interface (UI) and perform a corresponding operation by the processor; or may include a non-touch panel to receive a selection performed by a user by touching a button or key set around the panel on a displayed user interface and perform a corresponding operation by the processor.

In an embodiment of the present disclosure, the digital image server 20 may be a physical computer, such as a single server or a cluster formed by a plurality of servers; or may be a virtual storage server provided by a cloud computing environment.

In an embodiment of the present disclosure, the terminal 30 may be a fixed terminal, such as a desktop computer, or may be a mobile terminal, such as a notebook computer, or may be a handheld smart terminal, such as a mobile phone, a tablet computer, a personal digital assistant (PDA), or the like.

In an embodiment of the present disclosure, a network connection is a wireless network, a wired network, and/or any combination of the wireless network and the wired network. A network may include a local area network, the Internet, a telecommunications network, the Internet of Things based on the Internet and/or the telecommunications network, and/or any combination of the these networks, or the like. The wired network may perform communication by using, for example, a twisted pair, a coaxial cable, an optical fiber, a network cable, a data line (such as a USB, IEEE1394, a serial port, a parallel port), or the like, and the wireless network may perform communication by using, for example, a 3G/4G/5G mobile communication network, Bluetooth, Zigbee, Wi-Fi, or the like.

In an embodiment of the present disclosure, the digital image is a two-dimensional or three-dimensional image indicated in binary numeric pixels, for example, may be a bitmap image or a vector image. Formats of the digital image such as raster image formats BMP, GIF, JPEG, and PNG, as well as vector image formats WMF and SVG may all be applicable to the present disclosure.

In an embodiment of the present disclosure, the digital image client may be a computer program that is run by the processor, or may be an electronic device into which a required function dedicatedly used for performing the embodiments of the present disclosure is built. In one example, the digital image client may be an application program for implementing a network data interaction function. One or more users may perform an operation related to the digital image by using the digital image client, for example, a transaction of the digital image, like purchasing the digital image; for another example, daily communication related to the digital image and dealing with some daily affairs related to the digital image, like publishing the digital image or sharing the digital image. In one example, each user using the digital image client may set a plurality of network identities which are identifiable for other users in an information interaction network formed by the digital image clients. Each user has a contact list including other users, such that the user can communicate with the other users in the contact list by using instant messaging and the like. In one example, users logging on to digital image clients may communicate with each other by using the digital image clients.

In some embodiments, a user may register a user account with the digital image server 20, and the user account indicates a network identity of the user on the digital image client. The display apparatus 10 and the terminal 30 may be associated by using a same user account that is logged on to the digital image client, to perform a corresponding action simultaneously, for example, displaying a digital image simultaneously. The display apparatus 10 is configured to display the digital image, the digital image server 20 is configured to maintain the digital image, and the terminal 30 is configured to manage the display apparatus.

In some embodiments, the display apparatus may be used as a digital image frame which is a frame for displaying a digital image instead of a paper image. The digital image frame includes a frame body and a display screen. A user may transmit a collected digital image or photo to the digital image frame, such that the collected digital image or photo may be displayed on the display screen of the digital image frame.

In an embodiment of the present disclosure, the method for displaying the digital image is applied to an electronic device, and the electronic device may include a display apparatus or a terminal. As shown in FIG. 3, the method for displaying the digital image may include the following steps.

In step 101, information of a digital stamp associated with a target digital image is acquired.

The target digital image and the information of the digital stamp are both associated with a target user account.

In step 102, the digital stamp is displayed on the target digital image according to the information of the digital stamp in response to displaying the target digital image.

To sum up, in the method for displaying a digital image provided in this embodiment of the present disclosure, after receiving the information of the digital stamp, the electronic device controls the display apparatus to display the target digital image showing the digital stamp. The target digital image is associated with the digital stamp, and both the target digital image and the digital stamp are associated with the target user account. As such, the display apparatus can not only display the digital image, but also display the stamp associated with the digital image, thereby enriching display functions of the display apparatus.

The electronic device may include a display apparatus or a terminal. The method for displaying a digital image provided in this embodiment of the present disclosure is applicable to the two electronic devices. The method for displaying a digital image provided in this embodiment of the present disclosure may include at least one of a process of: obtaining the target digital image, obtaining the information of the digital stamp, and sharing the target digital image. The terminal may participate in performing all the three processes, or the display apparatus may perform all the three processes independently.

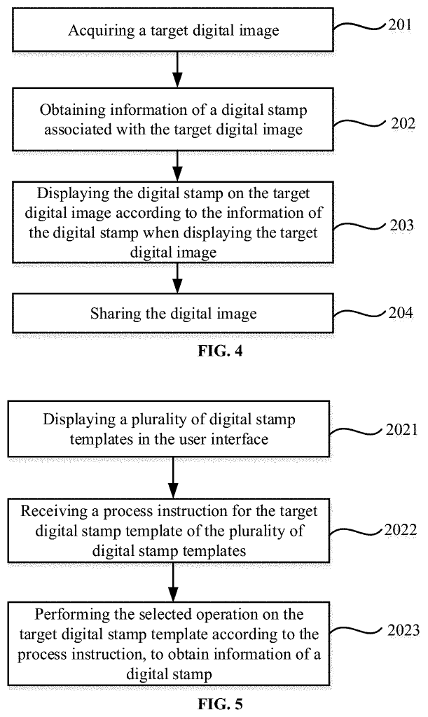

In some embodiments, the electronic device may include a display apparatus. The display apparatus performs the process of: acquiring the target digital image, acquiring the information of the digital stamp, and sharing the target digital image. The method for displaying a digital image may be applied to the implementation environment shown in FIG. 1. Referring to FIG. 4, the method may include the following steps.

In step 201, a target digital image is acquired from a display apparatus.

For example, the display apparatus receives a target digital image sent by a digital image server. Optionally, the target digital image may be a digital image purchased by using a target user account, or may be a digital image shared with an account associated with the target user account. This is not limited in this embodiment of the present disclosure.

After the target digital image is purchased by using the target user account, or after the target digital image is shared by the associated account with the target user account, the digital image server may associate the target digital image with the target user account, such that the target digital image is associated with the target user account. In this way, the target user account has ownership of the received target digital image, and other accounts cannot modify content displayed in the target digital image. As the target user account is logged on to a digital image client installed in the display apparatus, the digital image server may send the target digital image to the display apparatus based on the target user account by using the digital image client.

For example, the display apparatus receives the target digital image locally. Local receiving herein is in a means that the display apparatus receives the target digital image by using a hardware port of the display apparatus or hardware to which the display apparatus connected.

In some embodiments, the display apparatus may be provided with an image acquisition component, and collect the target digital image by using the image acquisition component. Optionally, the image acquisition component may be a camera or a scanner, and the display apparatus may obtain the target digital image by shooting or scanning an existing image.

In some embodiments, the display apparatus is provided with an input interface, and the display apparatus may receive the target digital image by the input interface. For example, the input interface is a USB, a LAN, a SATA, or the like. For example, the display apparatus is connected to the terminal by the USB port, such that the terminal receives the target digital image, this method of receiving the target digital image is also referred to as local receiving.

In the embodiment in which the display apparatus locally receives the target digital image, the target user account is logged on to the digital image client installed in the display apparatus. After acquiring the target digital image, the display apparatus may associate the target digital image with the target user account, and notify the digital image server to record the association relationship. As such, the target digital image is associated with the target user account, such that the target user account has ownership of the received target digital image, but other accounts cannot modify the content displayed in the target digital image.

In step 202, the display apparatus acquires information of a digital stamp associated with the target digital image.

For example, the display apparatus may receive the information of the digital stamp locally.

In some embodiments, the display apparatus may be controlled to display a user interface, such that a user may operate the user interface and the display apparatus acquires the information of the digital stamp. For example, as shown in FIG. 5, the manner may include the following steps.

In step 2021, the display apparatus displays a plurality of digital stamp templates in the user interface.

For example, the plurality of digital stamp templates may include a plurality of different template groups, wherein each template group corresponds to one type, and each template group includes one or more stamp templates in a same type. The template groups may be grouped in a plurality of ways, for example, grouped by style. In this way, the plurality of template groups may be grouped into a violent template group, a peaceful template group, and an elegant template group; or the plurality of template groups may be grouped into a classical template group and a trendy template group. For another example, grouping may be performed according to composition content. In this way, the plurality of template groups may be grouped into an image template group and a text template group. The image template group can be grouped into a plurality of template sub-groups according to image types, and the text template group may be grouped into a plurality of template sub-groups according to text types. This embodiment of the present disclosure is merely an example for description, and is not limited.

When browsing the target digital image by the display apparatus, a user may perform a template select operation on the display apparatus. Correspondingly, by receiving a template select instruction triggered by the template select operation, the display apparatus enters a template selection mode. The display apparatus may display the plurality of template groups in the user interface according to the template select instruction.

Optionally, the plurality of template groups may be displayed in a same user interface or different user interfaces. When the plurality of template groups are displayed in the different user interfaces, the user may control the switching of the user interfaces on which the plurality of template groups are displayed by a slide operation or the like.

For example, the template select operation may be a touch operation on a specified area of the display apparatus. The template select operation may be such as a tap operation, a double-tap operation, a press operation, or a slide operation. The specified area may be located in a display area or a non-display area of the display apparatus. The template select operation may be further an operation such as a press or rotate operation performed by a function button on the display apparatus.

In some embodiments, the display apparatus may be used as a digital image frame. A template display area is provided in the user interface. For example, the template display area is located at a bottom end of the user interface. A plurality of template groups may be displayed in the template display area, and the plurality of template groups include a template group (A), a template group (B), a template group (C), and a template group (D). If the template select operation is a tap operation performed on the template display area of the digital image frame, when the user taps any one of the template groups in the template display area (in other words, a select operation is performed), a select instruction for the template group may be triggered. For example, if a selected template group is the template group (A), the digital image frame displays a digital stamp template included in the template group (A) in the user interface, such that the user may select a target digital stamp template. Optionally, the digital image frame may directly display the digital stamp template included in the template group (A) in the user interface in which the template display area is located, or may switch to another user interface to display the digital stamp template included in the template group (A). It should be noted that the foregoing (A) to (D) are only exemplary identifiers of the template groups. Actually, the template groups may also be identified by using other character strings, for example, a text, wherein the text may indicate types corresponding to the template groups.

In some embodiments, a plurality of ungrouped digital stamp templates are displayed in the user interface displayed by the display apparatus.

When browsing the target digital image by the display apparatus, a user may perform a template select operation on the display apparatus. Correspondingly, by receiving a template select instruction triggered by the template select operation, the display apparatus enters into a template selection mode, and displays the plurality of digital stamp templates in the user interface according to the template select instruction.

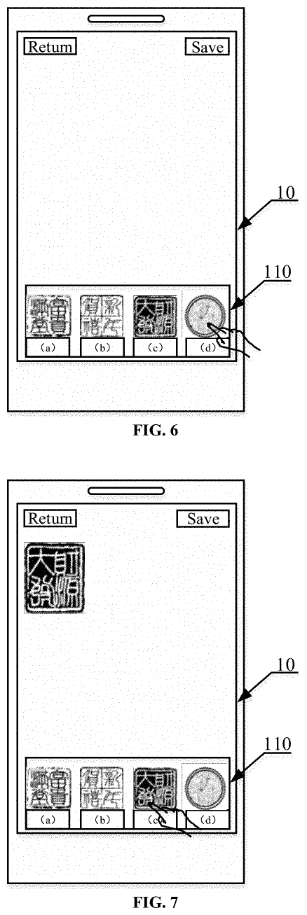

In one example, FIG. 6 is a schematic diagram of a user interface of a display apparatus according to an embodiment of the present disclosure. For example, the display apparatus may be used as a digital image frame. A template display area 110 is provided in the user interface 10, and a plurality of digital stamp templates are displayed in the template display area 110. For example, the plurality of digital stamp templates include a digital stamp template (a), a digital stamp template (b), a digital stamp template (c), and a digital stamp template (d). If the template select operation is a tap operation preformed on the template display area of the digital image frame, when tapping any digital stamp template in the template display area 110, the user may trigger a select instruction for the digital stamp template. If a selected digital stamp template is the digital stamp template (d), the digital image frame determines the digital stamp template (d) as the target digital stamp template selected by the user. It should be noted that the templates (a) to (d) are merely exemplary identifiers of the digital stamp templates. Actually, the digital stamp templates may also be identified by using other character strings, for example, a text, and wherein text may indicate content in the templates, such as “ZHANG”.

In some embodiments, after selecting the target digital stamp template, the user may perform a conformation operation. The display apparatus receives a confirmation instruction generated by the conformation operation, and saves information of the target digital stamp template according to the confirmation instruction. For example, the user interface displaying the digital stamp template in the display apparatus may further include a button identified by “Save”. The user may confirm again the select operation by tapping the button identified by “Save”.

For example, FIG. 7 is a schematic diagram of a user interface of a display apparatus according to an exemplary embodiment of the present disclosure. After the user selects the required target digital stamp template, the display apparatus may display the target digital stamp template in the user interface. For example, if the target digital stamp template selected by the user is the template (c), the display apparatus displays the template (c) in the user interface, and the user may save information of the target digital stamp by tapping the “Save” button.

It should be noted that description is provided by using an example in which four different digital stamp templates are displayed in the template display area in FIG. 6 and FIG. 7. However, a quantity, location, and type, and the like, of the digital stamp templates are not limited.

When requiring the display apparatus to exit the template selection mode, the user may perform an exit operation. The display apparatus receives an exit instruction generated by the exit operation, and returns to a previous interface of a current user interface according to the exit instruction. For example, the previous interface may be a display interface displaying a digital image. For example, the user interface displaying the digital stamp template in the display apparatus may further include a button identified by “Return”, and the user may control, by tapping the “Return” button, the display apparatus to return to the previous interface of the current user interface.

In some embodiments, the plurality of digital stamp templates are provided by the digital image server, and may be periodically updated, or may be updated triggered by the user. Therefore, the digital image server provides relatively abundant template types, thereby further improving user experience.

In some embodiments, the plurality of digital stamp templates are uploaded to the display apparatus by the user, in other words, the plurality of digital stamp templates are obtained by the display apparatus locally. As such, the provided digital stamp templates are more in line with preferences of users, thereby enhancing template personalization and meeting personalized demands of the users.

In step 2022, the display apparatus receives a process instruction for the target digital stamp template of the plurality of digital stamp templates.

The user may perform a selected operation on the target digital stamp template by the display apparatus. Correspondingly, the display apparatus receives a process instruction triggered by the selected operation. For example, the selected operation may be a touch operation on a specified area of the display apparatus. The selected operation may be a tap operation, a double-tap operation, a press operation, or a slide operation. The specified area may be located in a display area or a non-display area of the display apparatus. The selected operation may be further a press operation performed on a specified button arranged on the display apparatus, or the like.

In step 2023, the display apparatus performs the selected operation on the target digital stamp template according to the process instruction, to acquire the information of the digital stamp.

The process instruction is intended to instruct to perform the selected operation on the target digital stamp template. For example, the selected operation includes at least one of following: zooming, update, text addition, and graphic modification. A plurality of types of operations may improve diversity of digital stamps.

In one example, when a dimension of the target digital stamp template does not meet a requirement of the user, the user may control the display apparatus to perform zooming on the target digital stamp template by performing the process instruction, so as to adjust the dimension of the target digital stamp template to a dimension required by the user. Optionally, the dimension may be 5 centimeters×5 centimeters.

For example, when needing to modify the target digital stamp template, the user may control the display apparatus to perform the graphic modification processing on the target digital stamp template by performing the process instruction. The process instruction is intended to clip a part that the user does not need, or modify a part that the user is not satisfied with.

For example, the user may control the display apparatus to perform text addition processing on the target digital stamp template by performing the process instruction. The user may enter text or image information. After receiving the content entered by the user, the display apparatus adds the content to the target digital stamp template according to an indication of the user.

After obtaining the information of the digital stamp, the display apparatus performs a subsequent step 203.

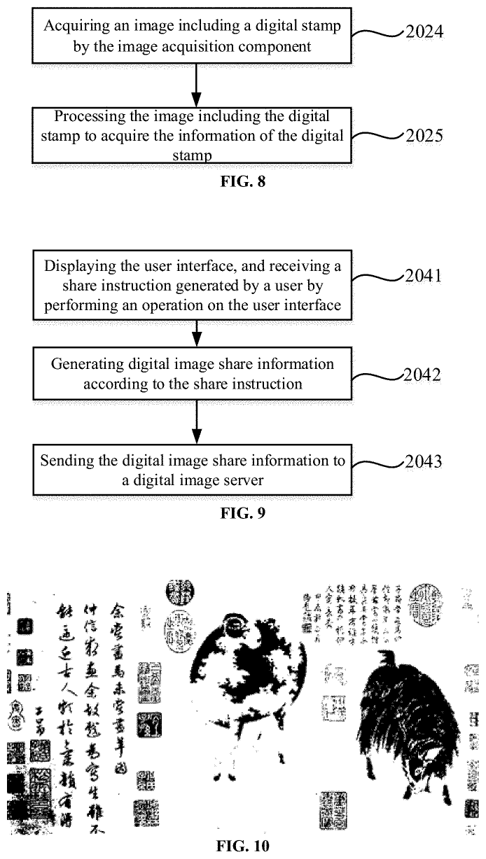

In some embodiments, the display apparatus receives the information of the digital stamp by an image acquisition component. For example, as shown in FIG. 8, receiving the information may include the following steps.

In step 2024, the display apparatus acquires an image including the digital stamp by the image acquisition component.

For example, the image acquisition component may be a camera. The display apparatus acquires the image including the digital stamp by scanning or shooting an existing stamp by the camera.

In step 2025, the display apparatus processes the image including the digital stamp to acquire the information of the digital stamp.

For example, the processing procedure may include: directly generating the information of the digital stamp by the display apparatus, and the information of the digital stamp includes the image including the digital stamp. In this way, the process of generating the information of the digital stamp is simple and flexible.

For another example, the processing procedure may include at least one of image extraction processing and image standardization processing. In some embodiments, the image extraction processing includes: after obtaining the image including the digital stamp by the camera, the display apparatus may identify a target area where the digital stamp is located in the image by using an image identification algorithm, clip the image to obtain the target area, then obtain the image including the digital stamp, and generate the information of the digital stamp according to the image including the digital stamp. The information of the digital stamp includes display information of the image including the digital stamp.

In some embodiments, the image standardization processing may include: processing a specified parameter in the display information of the image including the digital stamp, such that a processed specified parameter conforms to a standard.

For example, if the specified parameter includes at least one of a dimension and a resolution. When the specified parameter includes the dimension, the image standardization processing includes: processing the dimension in the display information of the image, such that a processed dimension is less than or equal to a specified dimension threshold; when the specified parameter includes the resolution, the image standardization processing includes: processing the resolution in the display information of the image, such that processed resolution is greater than or equal to a specified resolution threshold. For example, the specified dimension threshold is 5 centimeters×5 centimeters, and the specified resolution threshold is 300 dpi (dot per inch), wherein dpi is a quantity of pixels in a unit area, and a greater dpi indicates a clearer image including the digital stamp. The specified dimension threshold and the specified resolution threshold may be adjusted according to an actual case.

In some embodiments, the information of the digital stamp may include pattern information of the digital stamp, and the display information is information according to which the digital stamp is displayed. In this way, the information of the digital stamp obtained by the step 202 is actually the pattern information of the digital stamp.

In some embodiments, the information of the digital stamp includes pattern information and location information of the digital stamp, and the location information is intended to indicate a display location of the digital stamp on the target digital image.

When the information of the digital stamp includes only the pattern information of the digital stamp, the pattern information of the digital stamp is obtained by step 202, and step 202 further includes: acquiring the location information of the digital stamp.

For example, the display apparatus may generate the location information of the digital stamp according to a predetermined rule, or the display apparatus may receive the location information of the digital stamp entered by the user. For example, the predetermined rule may be as follows: a location indicated by the location information of the digital stamp is on an edge area of the target digital image and/or a blank area of the target digital image.

The blank area herein is an area with no text or image in the digital image.

In some embodiments, the display apparatus is used as a digital image frame. The information of the digital stamp is received by the digital image frame. Because the digital image frame has a relatively large screen dimension, and a displayed font is also relatively large correspondingly, thereby facilitating operations performed by the elderly or children.

After obtaining the information of the digital stamp, the display apparatus performs subsequent step 203.

In step 203, the display apparatus displays the digital stamp on the target digital image according to the information of the digital stamp when displaying the target digital image.

In some embodiments, the information of the digital stamp may include pattern information of the digital stamp, and when displaying the target digital image, the display apparatus may determine a target area according to a specified rule, and display the digital stamp in the target area on the target digital image according to the information of the digital stamp. For example, the specified rule includes: a location of the digital stamp is on an edge area of the target digital image and/or on a blank area of the target digital image.

In some embodiments, the information of the digital stamp includes pattern information and location information of the digital stamp. When displaying the target digital image, the display apparatus may display the digital stamp on a target area indicated by the location information of the target digital image according to the pattern information of the digital stamp.

In some embodiments, the digital stamp may be displayed in the target digital image in an embedding manner (that is, content displayed in the target area in the target digital image is erased, and the digital stamp is displayed in the target area).

In some embodiments, the digital stamp is directly displayed at an upper layer of the target digital image (in other words, the digital stamp is displayed on the target digital image in a superposition manner). Optionally, if the target area of the target digital image is a non-blank area, when the digital stamp is displayed at the upper layer of the target digital image, the digital stamp may be translucently displayed, so as to reduce coverage of the content displayed at a lower layer. If the target area of the target digital image is the blank area, when the digital stamp is displayed at the upper layer of the target digital image, the digital stamp may be displayed according to the original display information of the digital stamp.

Correspondingly, when the predetermined rule is a location indicated by the location information of the digital stamp is on the blank area of the target digital image. The method may further include: identifying the blank area in the target digital image. An identification method may include: identifying a text area and an image area in the target digital image, and taking an area other than the text area and the image area as the blank area.

The text area may be identified by: segmenting the target digital image into a plurality of areas, and classifying each area by a classifier to determine whether the area is a text area. The classifier herein is a pre-trained classifier configured to identify whether a text exists in an image.

The image area may be identified by: segmenting the target digital image into a plurality of areas, determining a sum of mean square differences of grayscale values of pixels in each area, and when the sum of the mean square differences of the pixels is greater than a threshold, taking the area as the image area. If the area is a blank area, grayscale values of pixels are equal, and the calculated sum of the mean square differences of grayscale values is relatively small.

Nevertheless, the method for identifying the text area and the image area are merely examples, and the methods for identifying the text area and the image area are not limited in the present disclosure.

In some embodiments, the display apparatus may be configured to include two display modes for displaying digital images: a stamp display mode and a non-stamp display mode. When the display apparatus is in the stamp display mode, if the digital image obtained by the display apparatus is associated with a digital stamp, the digital image and the digital stamp are simultaneously displayed. When the display apparatus is in a non-stamp display mode, if the digital image obtained by the display apparatus is associated with a digital stamp, the digital stamp is hidden while the digital image is displayed. In this case, an effect of displaying the digital image by the display apparatus is the same as an effect of displaying the digital image by a traditional display apparatus. In this way, the display apparatus may be downward-compatible with a display function of a current display apparatus.

The display apparatus may perform switching between the two modes in a plurality of ways. For example, the display apparatus may be configured to display a user interface displaying a button of switching display modes, or a physical button of switching the display modes arranged on the display apparatus. Each time the user triggers the button of switching the display modes, the display apparatus switches a display mode.

In step 204, the display apparatus shares the digital image.

For example, as shown in FIG. 9, a process in which the display apparatus shares the digital image may include the following steps.

In step 2041, the display apparatus displays the user interface, and receives a share instruction generated by a user by performing an operation on the user interface.

The user may perform a share operation on the display apparatus. Correspondingly, the display apparatus receives the share instruction triggered by the share operation. For example, the share operation may be a touch operation on a specified area of the display apparatus, such as a tap operation, a double-tap operation, a press operation, or a slide operation. The specified area may be a display area or a non-display area of the display apparatus. The processing operation may be further a press operation performed on a specified button arranged on the display apparatus.

In step 2042, the display apparatus generates digital image share information according to the share instruction.

The digital image share information includes digital image update information and target information. The digital image update information includes information of the target digital image and the information of the digital stamp. The target information includes information indicative of a user account at a receiving end shared with the digital image update information, and the target information is associated with the shared user account at the receiving end.

In some embodiments, on the digital image client of the display apparatus, different users may establish a social networking relationship by mutual confirmation, for example, friend each other or follow each other. When two users establish a social networking relationship, the two users become social network contacts of each other, in other words, the two users are associated with each other. For example, the user account at the receiving end may associate with the target user account by establishing a social networking relationship with the target user account. For example, if a user account follows a target user account on a social networking platform or a digital image social networking platform, when the target user account shares a digital image on the social networking platform, the user account is the user account at the receiving end.

In some embodiments, a group of users may perform self-selection to form a social networking relationship with each other, thereby forming a social group. Each member in the group is a social network contact of all other members in the group. For example, the user account at the receiving end may belong to a same social group as the target user account, so as to be associated with the target user account. For example, if a user account belongs to a same social networking group as the target user account, when the target user account shares a digital image in the social group, the user account is the user account at the receiving end.

In step 2043, the display apparatus sends the digital image share information to the digital image server.

The digital image share information is used by the digital image server to share the digital image update information with the user account at the receiving end indicated by the target information. In this way, after receiving the digital image share information, the digital image server may share the digital image update information with the user account at the receiving end indicated by the target information.

Both the target digital image and the information of the digital stamp are associated with the target user account, in other words, the target digital image and the information of the digital stamp may be mutually associated by the target user account. Therefore, for the target user account, the associated target digital image and the information of the digital stamp cannot be randomly modified by others in a subsequent circulation process.

For example, the digital image update information in the share instruction has an unchangeable attribute. The change includes deletion or modification, and a user is subsequently allowed only to add a digital stamp. Alternatively, the digital image update information in the share instruction has an attribute that a bottom layer is unchangeable. If the digital image update information needs to be changed, the digital image update information can be used only as a background at the bottom layer and a digital stamp is added to an upper layer of the digital image update information.

For example, the digital image update information in the share instruction is a piece of overall information. After receiving the digital image update information, a terminal corresponding to the user account at the receiving end may obtain information in the digital image update information as a new target digital image, so as to display the target digital image, or add a digital stamp to the target digital image. In this way, for actions executed by the terminal for adding the digital stamp, reference may be made to steps 201 to 203.

FIG. 10 is a schematic diagram of an exemplary digital image according to an embodiment of the present disclosure. The digital image is a digital image shared by a user a plurality of times. After the digital image is shared by the user the plurality of times, information of a digital stamp associated with a user account that has owned the digital image still exists on the digital image. For example, one digital image is shared by different user accounts 10 times, and each user account that has owned the digital image has added a digital stamp to the digital image. In other words, 10 different user accounts have owned the digital image, and the digital image has information of 10 different digital stamps. In this way, the digital image obtained by an eleventh user account has the information of the 10 different digital stamps, and situations of users corresponding to the previous user accounts may be briefly learned according to the information of the 10 different digital stamps.

In this way, after the display apparatus shares the digital image by using the user account, the information of the digital stamp associated with the user account still exists in the target digital image, such that a circulation history of the digital image can be marked, thereby enriching personal attributes of the digital image.

In the embodiment in which the electronic device includes the display apparatus, according to the method for displaying a digital image provided in this embodiment of the present disclosure, after receiving the information of the digital stamp, the display apparatus displays the target digital image with the digital stamp. The target digital image is associated with the digital stamp, and both the target digital image and the digital stamp are associated with the target user account. As such, the display apparatus not only can display the digital image, but also can display the stamp associated with the digital image. Moreover, the digital stamp is associated with the target user account, such that the displayed digital image is no longer a digital copy but has personal attributes, thereby enriching display functions of the display apparatus.

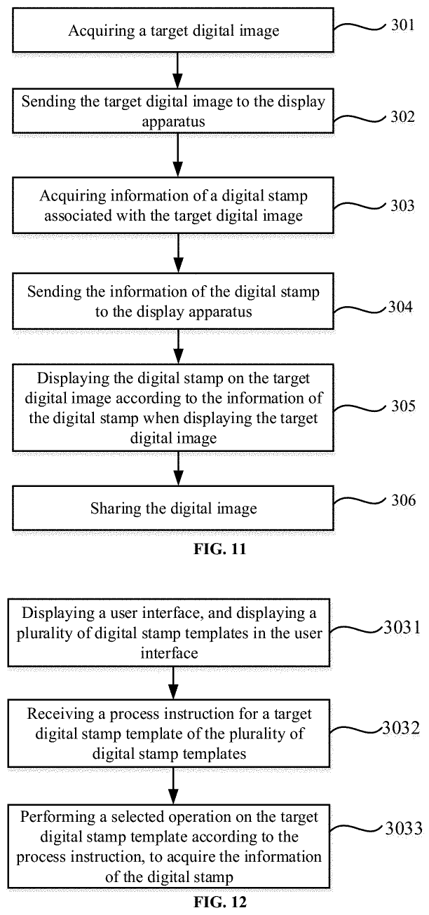

In some embodiments, the electronic device includes a terminal, the terminal participates in a process of obtaining the target digital image, a process of obtaining the information of the digital stamp, and a process of sharing the target digital image. The target user account is logged on to both the display apparatus and the digital image client installed in the terminal, wherein the target user account is a legal account registered on the digital image server, and the terminal is associated with the display apparatus by the target user account. In this case, the method for displaying a digital image may be applied to the implementation environment in FIG. 2. In this way, as shown in FIG. 11, the method may include the following steps.

In step 301, a terminal acquires a target digital image.

There may be a plurality of manners of obtaining the target digital image by the terminal. Exemplary description of the following three manners is provided in this embodiment of the present disclosure.

For example, the terminal receives the target digital image sent by a digital image server. Optionally, the target digital image may be a digital image purchased by a target user account, or may be a digital image shared with a terminal on which an account associated with the target user account is logged on to. This is not limited in this embodiment of the present disclosure.

In the embodiment in which the terminal receives the target digital image sent by the digital image server, after the target digital image is purchased by the target user account or is shared with the target user account by the terminal on to which the associated account is logged, the digital image server may associate the target digital image with the target user account, such that the target digital image is associated with the target user account. In this way, the target user account has ownership of the received target digital image, but other accounts cannot modify content in the target digital image. The target user account is logged on to the digital image client installed in the terminal. Therefore, the digital image server sends the target digital image to the terminal based on the target user account by the digital image client.

For example, the terminal receives a target digital image sent by another terminal.

The target user account is logged on to the digital image client installed in the current terminal, and the another account is logged on to a digital image client installed in an another terminal. The another account is associated with the target user account. The another terminal sends the target digital image to the digital image server by using the another account, and the digital image server associates the target digital image with the target user account, and shares the target digital image with the target user account, such that the target digital image is associated with the target user account. As such, the target user account has ownership of the received target digital image, but other accounts cannot modify content in the target digital image.

Optionally, the another terminal may also establish a communication connection to the terminal over a wired network or a wireless network on to which the target user account is logged, so as to send the digital image to the terminal on to which the target user account is logged. For example, the wireless network may be a Bluetooth network or a near field communication (NFC) network.

For example, the terminal receives the target digital image locally.

In some embodiments, the terminal may be provided with an image acquisition component which is configured to collect the target digital image. Optionally, the image acquisition component may be a camera which is configured to shoot or scan an existing image by the terminal, to obtain the target digital image.

In some embodiments, the terminal is provided with an input interface, and terminal may receive the target digital image by the input interface. For example, the input interface is a USB port (such as a micro USB or Type C).

In some embodiments, the terminal may provide a digital image drawing interface, receive a draw instruction performed on the digital image drawing interface, and draw the digital image according to the drawing interface to obtain the target digital image.

When the user performs a draw operation on the terminal, the terminal receives a draw instruction triggered by the draw operation, and displays a corresponding image according to the draw instruction.

For example, the draw operation may be a touch operation performed on a specified area of the terminal, such as a tap operation, a double-tap operation, a press operation, a smear operation, or a slide operation. The specified area may be a display area or a non-display area of the terminal. The draw operation may be further a press operation performed on a specified button arranged on the terminal.

In step 302, the terminal sends the target digital image to the display apparatus.

For example, the terminal may directly send the target digital image to the display apparatus over the wired network or the wireless network, and in this way, the display apparatus correspondingly receives the target digital image.

For example, both the terminal and the display apparatus are configured such that the target user account is logged on to, the terminal sends the target digital image to the digital image server, and the digital image server sends the target digital image to the display apparatus according to the target user account, and associates the target digital image with the target user account.

In step 303, the terminal acquires information of a digital stamp associated with the target digital image.

Both the target digital image and the information of the digital stamp are associated with the target user account. There may be a plurality of manners of the terminal obtaining the information of the digital stamp associated with the target digital image. Description is provided by using the following three receiving manners as examples in this embodiment of the present disclosure.

In one example, the terminal receives the information of the digital stamp sent by the digital image server.

In one example, the information of the digital stamp is generated and sent by another terminal to the digital image server, and the another terminal is a terminal associated with the current terminal. For example, a user account is logged on to a digital image client installed in the another terminal. In one implementation, the user account may establish a social relationship with the target user account, for example, friend each other or follow each other. The target user account sends the information of the digital stamp to the digital image server, and the digital image server sends the information of the digital stamp to the current terminal according to the foregoing social relationship. In another implementation, the user account may be in a same social networking group as the target user account. The target user account sends the information of the digital stamp to the social networking group, and then the digital image server sends the information of the digital stamp to the current terminal.

In one example, the terminal receives the information of the digital stamp sent by the another terminal.

The another terminal may also establish a communication connection to the terminal, over a wired network or a wireless network on to which the target user account is logged, so as to send the information of the digital stamp to the terminal on to which the target user account is logged. For example, the wireless network may be a Bluetooth network or an NFC network. The another terminal is a terminal associated with the current terminal. There may be a plurality of manners of associating the another terminal with the current terminal. For example, the another terminal establishes a communication connection to the current terminal, and therefore, the two are associated. Alternatively, the another terminal is a terminal specified by the current terminal, and therefore, the two are associated. Alternatively, a digital image client may be installed in the another terminal, the target user account is also logged on to a digital image client installed in the another terminal, and therefore, the two are associated, in other words, the current terminal and the another terminal are different terminals on which a same user account of a same user is logged on to, such as a mobile phone and a computer of one user.

For example, the terminal receives the information of the digital stamp locally.

A plurality of implementations in which the terminal receives the information of the digital stamp locally are available.

In some embodiments, the information of the digital stamp is received in a user interface displayed by the terminal. For example, as shown in FIG. 12, the manner may include the following steps.

In step 3031, the terminal displays the user interface, and displays a plurality of digital stamp templates in the user interface.

In step 3032, the terminal receives a process instruction for a target digital stamp template of the plurality of digital stamp templates.

The user may perform a selected operation on the target digital stamp template by the terminal. Correspondingly, the terminal receives a process instruction triggered by the selected operation.

In step 3033, the terminal performs a selected operation on the target digital stamp template according to the process instruction, to acquire the information of the digital stamp.

It should be noted that, for an implementation process of receiving the information of the digital stamp in the user interface of the terminal, reference may be made to the foregoing process of receiving the information of the digital stamp in the user interface of the display apparatus. In other words, for an implementation process from step 3031 to step 3033, correspondingly reference may be made to step 2021 to step 2023, and the details thereof are not given herein any further.

After obtaining the information of the digital stamp, the terminal performs subsequent step 304.

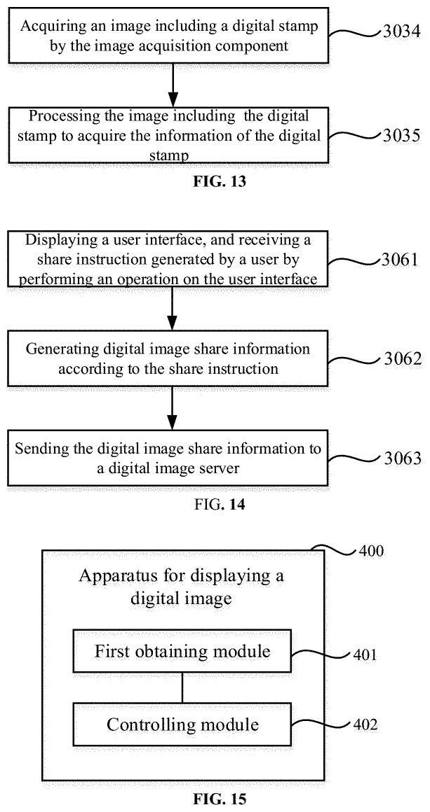

In some embodiments, the terminal receives the information of the digital stamp by an image acquisition component. For example, as shown in FIG. 13, the manner may include the following steps.

In step 3034, the terminal acquires an image including the digital stamp by the image acquisition component.

In step 3035, the terminal processes the image including the digital stamp to acquire the information of the digital stamp.

It should be noted that, for an implementation process in which the terminal receives the information of the digital stamp by the image acquisition component, reference can be made to the foregoing process in which the display apparatus receives the information of the digital stamp by the image acquisition component. In other words, for an implementation process of step 3034 and step 3035, correspondingly reference may be made to the foregoing step 2024 and step 2025, and the details thereof are not given herein any further.

After obtaining the information of the digital stamp, the terminal performs subsequent step 304.

In step 304, the terminal sends the information of the digital stamp to the display apparatus.

For example, the terminal may directly send the information of the digital stamp to the display apparatus over a wired network or a wireless network, and in this way, the display apparatus correspondingly receives the information of the digital stamp.

For example, both the terminal and the display apparatus are configured such that the target user account is logged on to. The terminal sends the information of the digital stamp to the digital image server, and the digital image server sends the information of the digital stamp to the display apparatus by using the target user account, and associates the information of the digital stamp with the target user account.

In step 305, the display apparatus displays the digital stamp on the target digital image according to the information of the digital stamp when displaying the target digital image.

For a process in which the display apparatus displays the digital image with the digital stamp, correspondingly reference may be made to step 203, and the details thereof are not given herein any further.

In step 306, the terminal shares the digital image.

For example, as shown in FIG. 14, a process in which the terminal shares the digital image may include the following steps.

In step 3061, the terminal displays a user interface, and receives a share instruction generated by a user by performing an operation on the user interface.

In step 3062, the terminal generates the digital image share information according to the share instruction.

In step 3063, the terminal sends the digital image share information to the digital image server.

It should be noted that, for a process in which the terminal shares the digital image, reference may be made to the foregoing process in which the display apparatus shares the digital image. In other words, for an implementation process from step 3061 to step 3063, correspondingly reference may be made to step 2041 to step 2043, and the details thereof are not given herein any further.

Those skilled in the art may clearly learned that, for a convenient and brief description, for an implementation process of the method embodiment of displaying the digital image with participation of the terminal, reference may be made to the method embodiment of displaying the digital image without participation of the terminal, and the details thereof are not given herein any further.

For an effect generated in the method for displaying a digital image provided in step 301 to step 306, reference may be made to FIG. 10. After receiving the information of the digital stamp, the terminal sends the information of the digital stamp to the display apparatus, and the display apparatus displays the target digital image with the digital stamp. The target digital image is associated with the digital stamp, and both the target digital image and the digital stamp are associated with the target user account. In this way, the display apparatus not only can display the digital image, but also can display the stamp associated with the digital image. Moreover, the digital stamp is associated with the target user account, such that the displayed digital image is no longer a digital copy but has personal attributes, thereby enriching display functions of the display apparatus.

It should be noted that step 201 describes a process in which the display apparatus obtains the target digital image without participation of the terminal, step 202 and step 203 describe a process in which the display apparatus obtains the information of the digital stamp and displays the digital stamp according to the information of the digital stamp without participation of the terminal, and step 204 describes a process in which the display apparatus shares the digital image without participation of the terminal.

Step 301 and step 302 describe a process in which the display apparatus obtains the target digital image with participation of the terminal, step 303 to step 305 describe a process in which the display apparatus obtains the information of the digital stamp and displays the digital stamp according to the information of the digital stamp with participation of the terminal, and step 306 describes a process in which the terminal shares the digital image.

The foregoing steps provided in the embodiments of the present disclosure may be combined according to an actual case. For example, the following several combinations may be included: step 201 to step 203 and step 306 may be sequentially performed; or step 201, step 303 to step 305, and step 204 may be sequentially performed; step 301, step 302 and step 202 to step 204 may be sequentially performed. There may be further a plurality of combinations. In practical applications, adjustment may be performed according to an actual case. This is not limited in this embodiment of the present disclosure.

When the electronic device includes a terminal, the user may directly receive the information of the digital stamp by the terminal, and send the information of the digital stamp to the display apparatus, so as to control the display apparatus to display the digital image with the digital stamp, thereby making an entire operation process convenient and flexible.

In this embodiment of the present disclosure, association is referred to establish a correspondence, to associate associated targets. For example, an associated target has an attribute corresponding to the association relationship. In one example, after the terminal is associated with the display apparatus, a corresponding attribute is synchronizing display information, or establishing a near field communication connection. In another example, after the digital image is associated with the information of the digital stamp based on a same user account, a corresponding attribute is that the two are integrated into an overall information, and another user account is allowed only to use the overall information as a new digital image and to add the digital stamp to the new digital image.

It should be noted that an order of the steps of the method for displaying a digital image provided in the embodiments of the present disclosure may be properly adjusted, and the steps may also be increased or decreased according to a case. Method to which mortifications readily figured out by those skilled in the art within the technical scope disclosed by the present disclosure shall fall within the protection scope of the present disclosure. Therefore, details are not described herein.

To sum up, in the method for displaying a digital image provided in the embodiments of the present disclosure, after receiving the information of the digital stamp, the electronic device controls the display apparatus to display the target digital image with the digital stamp. The target digital image is associated with the digital stamp, and both the target digital image and the digital stamp are associated with the target user account. The electronic device can further share the target digital image and the information of the associated digital image. As such, the display apparatus not only can display the digital image, but also can display the stamp associated with the digital image. Moreover, the digital stamp is associated with the target user account, such that the displayed digital image is no longer a digital copy but has personal attributes, thereby enriching display functions of the display apparatus. When sharing the digital image, the electronic device can simultaneously share the digital stamp associated with the digital image, and the digital stamp may not be erased, so as to indicate the ownership and a circulation history of the digital image, and further enhance meaningfulness of the digital image.

An embodiment of the present disclosure provides an apparatus for displaying a digital image. The apparatus for displaying a digital image is applied to an electronic device, and the electronic device may be a display apparatus or a terminal. This is not limited in this embodiment of the present disclosure. In this way, as shown in FIG. 15, the apparatus 400 for displaying a digital image includes:

a first acquiring module 401, configured to acquire information of a digital stamp associated with a target digital image, wherein both the target digital image and the information of the digital stamp are associated with a target user account; and

a controlling module 402, configured to control the display apparatus to display the digital stamp on the target digital image according to the information of the digital stamp in response to displaying the target digital image.

To sum up, in the apparatus for displaying a digital image provided in this embodiment of the present disclosure, after receiving the information of the digital stamp, the first acquiring module controls the display apparatus to display the target digital image with the digital stamp. The target digital image is associated with the digital stamp, and both the target digital image and the digital stamp are associated with the target user account. In this way, the display apparatus not only can display the digital image, but also can display the stamp associated with the digital image, thereby enriching display functions of the display apparatus.

The electronic device may be the display apparatus or the terminal. The apparatus for displaying a digital image provided in this embodiment of the present disclosure is applicable to both the electronic devices. Description is separately provided by using the following two implementable manners as examples in this embodiment of the present disclosure.

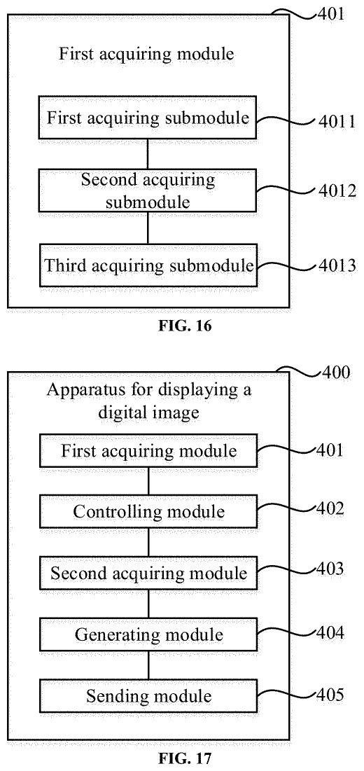

In some embodiments, the electronic device includes the display apparatus, and the display apparatus is configured to display the digital image. In this case, as shown in FIG. 16, the first acquiring module 401 includes:

a first acquiring submodule 4011, configured to receive the information of the digital stamp sent by a digital image server, wherein the information of the digital stamp is generated and sent by the terminal to the digital image server; or

a second acquiring submodule 4012, configured to receive the information of the digital stamp sent by the terminal; or

a third acquiring submodule 4013, configured to receive the information of the digital stamp locally from the electronic device;

wherein the terminal and the display apparatus are associated with the target user account.

In one example, the controlling module 402 is configured to control the electronic device to display a user interface, and display a plurality of digital stamp templates in the user interface.

The third acquiring submodule 4013 is configured to receive a process instruction for a target digital stamp template of the plurality of digital stamp templates. The process instruction is intended to instruct to perform a selected operation on the target digital stamp template.

The controlling module 402 is configured to perform the selected operation on the target digital stamp template according to the process instruction, to acquire the information of the digital stamp.

For example, the selected operation includes at least one of zooming, update, text addition, and graphic modification.

Optionally, the third acquiring submodule 4013 may be further configured to acquire an image including the digital stamp by an image acquisition component.

The controlling module 402 may be further configured to process the image including the digital stamp to acquire the information of the digital stamp.

The information of the digital stamp may include pattern information and location information of the digital stamp.

For example, the controlling module 402 may be further configured to control the display apparatus to display the digital stamp on a target area indicated by the location information of the target digital image according to the pattern information of the digital stamp.

In a second implementable, the electronic device is the terminal, and the first acquiring module 401 includes:

a first acquiring submodule 4011, configured to receive the information of the digital stamp sent by a digital image server, wherein the information of the digital stamp is generated and sent by an another terminal to the digital image server; or

a second acquiring submodule 4012, configured to receive the information of the digital stamp sent by the another terminal; or

a third acquiring submodule 4013, configured to receive the information of the digital stamp locally from the electronic device.

In one example, the controlling module 402 is configured to control the electronic device to display a user interface and display a plurality of digital stamp templates in the user interface.

The third acquiring submodule 4013 is configured to receive a process instruction for a target digital stamp template of the plurality of digital stamp templates. The process instruction is intended to instruct to perform a selected operation on the target digital stamp template.

The controlling module 402 is configured to perform the selected operation on the target digital stamp template according to the process instruction, to acquire the information of the digital stamp.

For example, the selected operation includes at least one of zooming, update, text addition, and graphic modification.

Optionally, the third acquiring submodule 4013 may be further configured to acquire an image including the digital stamp by an image acquisition component.

The controlling module 402 may be further configured to process the image including the digital stamp to acquire the information of the digital stamp.

The information of the digital stamp may include pattern information and location information of the digital stamp.

In one example, the controlling module 402 is configured to:

send the information of the digital stamp to the display apparatus by the digital image server, wherein the display apparatus is configured to display the digital image; the information of the digital stamp is intended to display the digital stamp by the display apparatus when the target digital image is displayed; and the terminal and the display apparatus are associated with the target user account.

Optionally, as shown in FIG. 17, the apparatus for displaying a digital image may further include:

a second acquiring module 403, configured to control the electronic device to display the user interface, and receive a share instruction generated by a user by performing an operation performed on the user interface;

a generating module 404, configured to generate digital image share information according to the share instruction, wherein the digital image share information includes digital image update information and target information, the digital image update information including information of the target digital image and the information of the digital stamp, the target information including information indicative of a user account at a receiving end shared with the digital image update information, and the target information being associated with the user account; and

a sending module 405, configured to send the digital image share information to the digital image server, wherein the digital image share information is intended to share the digital image update information with the user account at the receiving end indicated by the target information by the digital image server.

To sum up, in the apparatus for displaying a digital image provided in this embodiment of the present disclosure, after the first acquiring module receives the information of the digital stamp, the controlling module controls the display apparatus to display the target digital image with the digital stamp. The target digital image is associated with the digital stamp, and both the target digital image and the digital stamp are associated with the target user account. The apparatus for displaying a digital image may further generate the digital image share information by the generating module according to the share instruction received by the second acquiring module, and then send the digital image share information to the digital image server by the sending module, so as to share the target digital image and the information of the associated digital stamp. In this way, the display apparatus not only can display the digital image, but also can display the stamp associated with the digital image, thereby enriching display functions of the display apparatus. When sharing the digital image, the apparatus for displaying a digital image can simultaneously share the digital stamp associated with the digital image, and the digital stamp may not be erased, so as to indicate ownership and a circulation history of the digital image, and further enhance meaningfulness of the digital image.

In this embodiment of the present disclosure, the module may be implemented by a processor running software, or may be implemented by a circuit designed to implement a corresponding function of the module. In one example, a related acquiring module and the like may be executed by related hardware, such as a network module (for example, performing data interaction with a server or another apparatus) or a touch module (for example, receiving an operation by a user performed on a display panel). In another example, a related controlling module may be executed by the processor or the like.

Those skilled in the art may clearly learned that, for a convenient and brief description, for a detailed working process of the modules and submodules of the above-described apparatus for displaying a digital image, reference may be made to a corresponding process in the foregoing method embodiment, and the details thereof are not given herein any further.

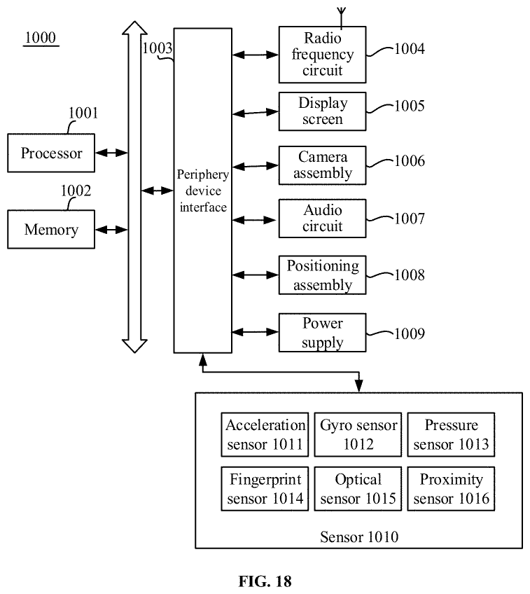

An embodiment of the present disclosure provides an electronic device. FIG. 18 is a schematic structural diagram of an electronic device 1000 according to an embodiment of the present disclosure. The electronic device 1000 may be any product or component having a display function, such as a digital image frame, a liquid crystal display panel, electronic paper, an OLED panel, a mobile phone, a tablet computer, a television, a display, a notebook computer, a digital photo frame, or a navigator. The display apparatus includes a controller and a plurality of source driving chips, and the controller is at least one of a timing controller, an SOC, and an MCU. Usually, the electronic device 1000 further includes: a processor 1001 and a memory 1002. The memory 1002 is configured to store at least one executable instruction and at least one computer instruction of the processor. When running the computer instruction, the processor 1001 is enabled to perform one or more steps of the method for displaying a digital image according to the above embodiment.

The processor 1001 may include one or more processing cores, and is, for example, a quad-core processor or an octa-core processor. The processor 1001 may be implemented in at least one of the following hardware forms: a digital signal processing (DSP), a field-programmable gate array (FPGA), and a programmable logic array (PLA). The processor 1001 may also include a main processor and a co-processor. The main processor is a processor for processing data in a wake-up state, and is also referred to as a central processing unit (CPU). The co-processor is a low-power-consumption processor for processing data in a standby state. In some embodiments, the processor 1001 may be integrated with a graphics processing unit (GPU), and the GPU is configured to render and draw content to be displayed on a display screen. In some embodiments, the processor 1001 may further include an artificial intelligence (AI) processor, and the AI processor is configured to process calculation operations related to machine learning.

The memory 1002 may include one or more computer-readable storage media that may be non-transitory. The memory 1002 may further include a high-speed random access memory and a non-volatile memory, such as one or more magnetic disk storage devices and flash memory storage devices. In some embodiments, the non-transitory computer-readable storage medium in the memory 1002 is configured to store at least one instruction, and the at least one instruction is executed by the processor 1001 to implement the method for displaying a digital image provided by in method embodiment in this application.

In one example, the electronic device 1000 may further include: a peripheral device interface 1003 and at least one peripheral device. The processor 1001, the memory 1002, and the peripheral device interface 1003 may be connected by a bus or a signal cable. Each peripheral device may be connected to the other peripheral devices by a bus, a signal cable, or a circuit board. Specifically, the peripheral device includes at least one of: a radio frequency circuit 1004, a display screen 1005, a camera assembly 1006, an audio circuit 1007, a positioning assembly 1008, and a power supply 1009.

The peripheral device interface 1003 may be configured to connect at least one peripheral device related to input/output (I/O) to the processor 1001 and the memory 1002. In an optional embodiment, the processor 1001, the memory 1002, and the peripheral device interface 1003 are integrated on a same chip or circuit board. In another optional embodiment, any one or two of the processor 1001, the memory 1002, and the peripheral device interface 1003 may be implemented on an independent chip or circuit board. This is not limited in this embodiment of the present disclosure.

In one example, the radio frequency circuit 1004 is configured to receive and transmit a radio frequency (RF) signal, also referred to as an electromagnetic signal. The radio frequency circuit 1004 communicates with a communication network and another communications device by the electromagnetic signal. The radio frequency circuit 1004 may convert an electrical signal into an electromagnetic signal for sending, or convert the received electromagnetic signal into an electrical signal. Optionally, the radio frequency circuit 1004 includes: an antenna system, an RF transceiver, one or more amplifiers, a tuner, an oscillator, a digital signal processor, a codec chipset, a user identity module card, and the like. The radio frequency circuit 1004 may communicate with another apparatus using at least one wireless communication protocol. The wireless communication protocol includes, but is not limited to: World Wide Web, a metropolitan area network, an intranet, various generations of mobile communication networks (2G, 3G, 4G, and 5G), a wireless local area network, and/or a WIFI network. In some embodiments, the radio frequency circuit 1004 may further include an NFC-related circuit. This is not limited in this embodiment of the present disclosure.

For example, the display screen 1005 is configured to display a user interface. The user interface may include a graphic, a text, an icon, a video, and any combination thereof. When the display screen 1005 is a touch display screen, the display screen 1005 further has a capability to collect a touch signal on or above a surface of the display screen 1005. The touch signal may be input to the processor 1001 as a control signal for processing. In this case, the display screen 1005 may be further configured to provide a virtual button and/or a virtual keyboard, also referred to as a soft button and/or a soft keyboard. In an optional embodiment, there may be one display screen 1005, which is disposed on a front panel of the electronic device 1000. In some other embodiments, there may be at least two display screens 1005, which are respectively disposed on different surfaces of the electronic device 1000 or in a folding design. In another optional embodiment, the display screen 1005 may be a flexible display screen, and is disposed on a curved surface or a folding surface of the electronic device 1000. Optionally, the display screen 1005 may also be set as a non-rectangular irregular graphic, that is, a special-shaped screen. The display screen 1005 may be made of a material, such as a LCD or an OLED.

For example, the camera assembly 1006 is configured to collect an image or a video. Optionally, the camera assembly 1006 includes a front camera and a rear camera. Usually, the front camera is disposed on the front panel of the apparatus, and the rear camera is disposed on the back of the apparatus. In an optional embodiment, there are at least two rear cameras, which are respectively any one of a main camera, a depth-of-field camera, a wide-angle camera, and a long-focus camera, such that the main camera and the depth-of-field camera may be fused to achieve a bokeh function, the main camera and the wide-angle camera may be fused to achieve a panoramic shooting function and a virtual reality (VR) shooting function or another fusion shooting function. In another optional embodiment, the camera assembly 1006 may further include a flash. The flash can be a single-color-temperature flash or a dual-color-temperature flash. The dual-color-temperature flash is a combination of a warm-light flash and a cold-light flash, and may be used for light compensation at different color temperatures.

For example, the audio circuit 1007 may include a microphone and a speaker. The microphone is configured to: collect sound waves of a user and an environment, convert the sound waves into electrical signals which is input to the processor 1001 for processing, or to the radio frequency circuit 1004 to implement voice communication. There may be a plurality of microphones, which are respectively arranged at different parts of the electronic device 1000, so as to achieve stereo sound collection or noise reduction. The microphone may also be an array microphone or an omnidirectional collection microphone. The speaker is configured to convert an electrical signal from the processor 1001 or the radio frequency circuit 1004 into a sound wave. The speaker may be a traditional thin-film speaker or a piezoelectric ceramic speaker. When the speaker is a piezoelectric ceramic speaker, the speaker may not only convert an electrical signal into a sound wave audible to humans, but also convert an electrical signal into a sound wave inaudible to humans for ranging and other purposes. Optionally, the audio circuit 1007 may further include a headphone jack.

In one example, the positioning assembly 1008 is configured to navigate a current geographic location of the electronic device 1000, to implement navigation or a location based service (LBS). The positioning assembly 1008 may be the global positioning system (GPS) from the United States, the Beidou positioning system from China, the Grenas satellite positioning system from Russia or the Galileo satellite navigation system from the European Union.

For example, the power supply 1009 is configured to supply power to components of the electronic device 1000. The power supply 1009 may be an alternating current battery, a direct current battery, a disposable battery, or a rechargeable battery. When the power supply 1009 includes a rechargeable battery, the rechargeable battery may be a wired rechargeable battery or a wireless rechargeable battery. The wired rechargeable battery is a battery charged over a wired line, and the wireless rechargeable battery is a battery charged over a wireless coil. The rechargeable battery may also be configured to support a fast charging technology.

Optionally, the electronic device 1000 may further include one or more sensors 1010. The one or more sensors 1010 may include: an acceleration sensor 1011, a gyroscope sensor 1012, a pressure sensor 1013, a fingerprint sensor 1014, an optical sensor 1015, and a proximity sensor 1016.

The acceleration sensor 1011 may detect acceleration on three coordinate axes of a coordinate system established according to the electronic device 1000. For example, the acceleration sensor 1011 may be configured to detect components of gravity acceleration on the three coordinate axes. The processor 1001 may control the touch display screen 1005 to display a user interface in a horizontal view or a vertical view according to a gravity acceleration signal collected by the acceleration sensor 1011. The acceleration sensor 1011 may be further configured to collect movement data of a game or user.

The gyroscope sensor 1012 may detect a body direction and a rotation angle of the electronic device 1000, and the gyroscope sensor 1012 can cooperate with the acceleration sensor 1011 to collect a 3D action of the user on the electronic device 1000. The processor 1001 may implement the following functions according to the data collected by the gyroscope sensor 1012: motion sensing (such as changing a user interface according to a tilt operation of the user), image stabilization during shooting, game control, and inertial navigation.

The pressure sensor 1013 may be disposed on a side frame of the electronic device 1000 and/or at a lower layer of the touch display screen 1005. When the pressure sensor 1013 is disposed on the side frame of the electronic device 1000, the pressure sensor 1013 may detect a holding signal of the user to the electronic device 1000, and the processor 1001 can perform left-right hand identification or a shortcut operation according to the holding signal captured by the pressure sensor 1013. When the pressure sensor 1013 is disposed at the lower layer of the touch display screen 1005, the processor 1001 controls an operability control on the UI interface according to a pressure operation of the user performed on the touch display screen 1005. The operability control includes at least one of a button control, a scroll bar control, an icon control, and a menu control.

The fingerprint sensor 1014 is configured to collect a fingerprint of the user, and the processor 1001 identifies an identity of the user according to the fingerprint collected by the fingerprint sensor 1014, or the fingerprint sensor 1014 identifies an identity of the user according to the collected fingerprint. When the identity of the user is identified as a trusted identity, the processor 1001 authorizes the user to perform a related sensitive operation, including unlocking a screen, viewing encrypted information, downloading software, paying, changing settings, and the like. The fingerprint sensor 1014 may be disposed on a front surface, back surface, or side surface of the electronic device 1000. When a physical key or a trademark of a manufacturer is disposed on the electronic device 1000, the fingerprint sensor 1014 may be integrated with the physical key or the trademark of the manufacturer.

The optical sensor 1015 is configured to collect ambient light intensity. In an optional embodiment, the processor 1001 may control display brightness of the touch display screen 1005 according to the ambient light intensity collected by the optical sensor 1015. Specifically, when the ambient light intensity is relatively high, the display brightness of the touch display screen 1005 is increased; when the ambient light intensity is low, the display brightness of the touch display screen 1005 is reduced. In another optional embodiment, the processor 1001 may also dynamically adjust a shooting parameter of the camera assembly 1006 according to the ambient light intensity collected by the optical sensor 1015.

The proximity sensor 1016, also referred to as a distance sensor, is usually disposed on the front panel of the electronic device 1000. The proximity sensor 1016 is configured to collect a distance between the user and the front surface of the electronic device 1000. In an embodiment, when the proximity sensor 1016 detects that the distance between the user and the front surface of the electronic device 1000 is gradually becoming smaller, the processor 1001 controls the touch display 1005 to switch from a screen-on state to a screen-off state; when the proximity sensor 1016 detects that the distance between the user and the front surface of the electronic device 1000 gradually becomes larger, the processor 1001 controls the touch display screen 1005 to switch from a screen-off state to a screen-on state.

Those skilled in the art may understand that the structure shown in FIG. 18 does not constitute a limitation to the electronic device 1000, and may include more or fewer components than those shown in the figure, or some components are combined, or different component arrangements are used.

An embodiment of the present disclosure provides a system for displaying a digital image. The system for displaying a digital image includes an electronic device, and the electronic device may include any apparatus for displaying a digital image provided in the embodiment of the present disclosure. For a structure of the system for displaying a digital image, reference can be made to the system shown in FIG. 1 or FIG. 2 described above.

To sum up, in the system for displaying a digital image provided in this embodiment of the present disclosure, after receiving information of a digital stamp, the electronic device controls a display apparatus to display a target digital image with the digital stamp. The target digital image is associated with the digital stamp, and both the target digital image and the digital stamp are associated with a target user account. The electronic device can further share the target digital image and the information of the associated digital stamp. In this way, the display apparatus not only can display the digital image, but also can display the stamp associated with the digital image, thereby enriching display functions of the display apparatus. When sharing the digital image, the electronic device can simultaneously share the digital stamp associated with the digital image, and the digital stamp may not be erased, so as to indicate ownership and a circulation history of the digital image, and further enhance meaningfulness of the digital image.

It is obvious that the described embodiments are part rather than all of the embodiments of the present disclosure. All other embodiments obtained by those of ordinary skill in the art based on the embodiments of the present disclosure without creative work are within the scope of protection of the present disclosure.

Other embodiments of the present disclosure are apparent to those skilled in the art from consideration of the specification and practice of the present disclosure. This application is intended to cover any variations, uses, or adaptations of the present disclosure following the general principles thereof and including common knowledge or commonly used technical measures which are not disclosed herein. The specification and embodiments are to be considered as exemplary only, and the true scope and spirit of the present disclosure are subject to the appended claims.

It is appreciated that the present disclosure is not limited to the exact construction that has been described above and illustrated in the accompanying drawings, and that various modifications and changes can be made without departing from the scope thereof. It is intended that the scope of the present disclosure is only limited by the appended claims.

What is claimed is:

1. A method for displaying a digital image, applicable to an electronic device, comprising:
acquiring information of a digital stamp associated with a target digital image, wherein both the target digital image and the information of the digital stamp are associated with a target user account; and
displaying the digital stamp on the target digital image according to the information of the digital stamp in response to displaying the target digital image.

2. The method according to claim 1, wherein acquiring the information of the digital stamp associated with the target digital image comprises:
receiving the information of the digital stamp sent by a digital image server, wherein the information of the digital stamp is generated and sent by a terminal to the digital image server; or
receiving the information of the digital stamp sent by the terminal; or
acquiring the information of the digital stamp locally from the electronic device;
wherein the terminal is associated with the target user account.

3. The method according to claim 2, wherein acquiring the information of the digital stamp locally from the electronic device comprises:
controlling the electronic device to display a user interface, and displaying a plurality of digital stamp templates in the user interface;
receiving a process instruction for a target digital stamp template of the plurality of digital stamp templates, wherein the process instruction is intended to instruct to perform a selected operation on the target digital stamp template; and
performing the selected operation on the target digital stamp template according to the process instruction, to acquire the information of the digital stamp.

4. The method according to claim 3, wherein
the selected operation comprises at least one of: zooming, update, text addition, and graphic modification.

5. The method according to claim 2, wherein acquiring the information of the digital stamp locally from the electronic device comprises:
acquiring, by an image acquisition component coupled to the electronic device, an image comprising the digital stamp; and
processing the image comprising the digital stamp to acquire the information of the digital stamp.

6. The method according to claim 1, further comprising:
controlling the electronic device to display a user interface, and receiving a share instruction generated by a user by performing an operation on the user interface;
generating digital image share information according to the share instruction, wherein the digital image share information comprises digital image update information and target information, the digital image update information comprising information of the target digital image and the information of the digital stamp, the target information comprising information indicative of a user account at a receiving end shared by the digital image update information, and the target information being associated with the user account; and
sending the digital image share information to the digital image server, wherein the digital image share information is intended to share the digital image update information with the user account at the receiving end indicated by the target information by the digital image server.

7. The method according to claim 1, wherein the information of the digital stamp comprises pattern information of the digital stamp and location information of the digital stamp.

8. The method according to claim 7, wherein displaying the digital stamp on the target digital image according to the information of the digital stamp in response to displaying the target digital image comprises:
displaying the digital stamp on a target area indicated by the location information of the target digital image according to the pattern information of the digital stamp.

9. The method according to claim 7, wherein the location information of the digital stamp indicates that the digital stamp locates on an edge area of the target digital image or locates on a blank area of the target digital image.

10. The method according to claim 9, wherein when the location information of the digital stamp indicates that the digital stamp locates on the blank area of the target digital image, the method further comprises:
identifying a text area and an image area in the target digital image, and taking an area in the target digital image other than the text area and the image area as the blank area.

11. The method according to claim 1, wherein prior to acquiring the information of the digital stamp associated with the target digital image, the method further comprises:
receiving the target digital image sent by the digital image server, wherein the target digital image is a digital image purchased with the target user account, or a digital image shared by an account associated with the target user account, or a digital image uploaded by a terminal that is logged on to by using the target user account; and
associating the target digital image with the target user account.

12. An apparatus for displaying a digital image, applicable to an electronic device, comprising:
a first acquiring module, configured to acquire information of a digital stamp associated with a target digital image, wherein both the target digital image and the information of the digital stamp are associated with a target user account; and
a controlling module, configured to control the display apparatus to display the digital stamp on the target digital image according to the information of the digital stamp in response to displaying the target digital image.

13. The apparatus according to claim 12, wherein the first acquiring module comprises:
a first acquiring submodule, configured to receive the information of the digital stamp sent by a digital image server, wherein the information of the digital stamp is generated and sent by a terminal to the digital image server; or
a second acquiring submodule, configured to receive the information of the digital stamp sent by the terminal; or
a third acquiring submodule, configured to acquire the information of the digital stamp locally from the electronic device;
wherein the terminal is associated with the target user account.

14. The apparatus according to claim 13, wherein
the controlling module is configured to control the electronic device to display a user interface, and display a plurality of digital stamp templates in the user interface;
the third acquiring submodule is configured to receive a process instruction for a target digital stamp template of the plurality of digital stamp templates, wherein the process instruction is intended to instruct to perform a selected operation on the target digital stamp template; and
the controlling module is configured to perform the selected operation on the target digital stamp template according to the process instruction, to acquire the information of the digital stamp.

15. The apparatus according to claim 13, wherein
the third acquiring submodule is configured to acquire an image comprising the digital stamp by an image acquisition component;
the controlling module is further configured to process the image comprising the digital stamp to acquire the information of the digital stamp.

16. The apparatus according to claim 12, further comprising:
a second acquiring module, configured to control the electronic device to display a user interface, and receive a share instruction generated by a user by performing an operation on the user interface;
a generating module, configured to generate digital image share information according to the share instruction, wherein the digital image share information comprises digital image update information and target information, the digital image update information comprising information of the target digital image and the information of the digital stamp, the target information comprising information indicative of a user account at a receiving end shared by the digital image update information, and the target information being associated with the user account; and
a sending module, configured to send the digital image share information to the digital image server, wherein the digital image share information is intended to share the digital image update information with the user account at the receiving end indicated by the target information by the digital image server.

17. The apparatus according to claim 12, wherein the information of the digital stamp comprises pattern information of the digital stamp and location information of the digital stamp; and
the controlling module is configured to display the digital stamp on a target area indicated by the location information of the target digital image according to the pattern information of the digital stamp.

18. The apparatus according to claim 17, wherein the location information of the digital stamp indicates that the digital stamp locates on an edge area or locates on a blank area of the target digital image; and
the controlling module is further configured to identify a text area and an image area in the target digital image, and take an area in the target digital image other than the text area and the image area as the blank area.

19. An electronic device, comprising:
a processor; and
a memory configured to store at least one computer instruction;
wherein when running the at least one computer instruction, the processor is enabled to perform the method for displaying the digital image as defined in claim 1.

20. A computer-readable storage medium storing at least one computer instruction therein, wherein when the at least one computer instruction in the computer-readable storage medium is executed by a processor in an electronic device, the electronic device is enabled to perform the method for displaying the digital image as defined in claim 1.
